(19) United States
(12) Patent Application Publication
(10) Pub. No.: US 2002/0184821 A1
(43) Pub. Date: Dec. 12, 2002

(54) Plant pot cover system

(76) Inventor: Bonnie L. Campeau, Ludington, MI (US)

Correspondence Address: Michael S. Neustel, Suite No. 4, 2534 South University Drive, Fargo, ND, 58103, US

(21) Appl. No.: 09/878,931

(22) Filed: Jun. 11, 2001

(51) Int. Cl. A01G 9/02

(52) U.S. Cl. 47/72

(57) ABSTRACT

A plant pot cover system for providing a simple and convenient means for decorating a plant pot without disturbing the plant. The plant pot cover system includes a cover having an upper rim formed to fit about a pot, and a plurality of securing tabs to firmly fix the cover about the exterior surface of the pot. The cover may be comprised of various materials, colors, designs, shapes and appearances to provide an aesthetically pleasing appearance to the pot.

### BACKGROUND OF THE INVENTION

1. Field of the Invention

The present invention relates generally to plant pot covers and more specifically it relates to a plant pot cover system for providing a simple and convenient means for decorating a plant pot without disturbing the plant.

2. Description of the Prior Art

Plant pots have been in use for years. Typically, a conventional plant pot is comprised of a cylindrical structure having an upper opening for receiving a volume of soil and a plant. Conventional plant pots are not always suitable for the decor and aesthetics of a room. More particularly, when an individual purchases a plant from a store they often times must transplant the plant into a new pot that coordinates with the decor of the room. Transplanting a plant can damage a plant resulting in the death of the plant or stunting of the overall growth.

Examples of patented pot devices which are illustrative of such prior art include U.S. Pat. No. 5,519,967 to Weder et al; U.S. Pat. No. 4,014,506 to Hanson; U.S. Pat. No. 6,108,974 to Herzog-Mesrobian et; U.S. Pat. No. 4,914,860 to Richardson; U.S. Pat. No. 4,771,573 to Stengel; U.S. Pat. No. 5,020,274 to Wong; U.S. Pat. No. 1,357,738 to Squires; U.S. Pat. No. 4,229,904 to Burton; U.S. Pat. No. 1,249,973 to Lutey.

While these devices may be suitable for the particular purpose to which they address, they are not as suitable for providing a simple and convenient means for decorating a plant pot without disturbing the plant. Conventional plant pots are not suitable for being versatile in their appearance without requiring transplanting of a plant.

In these respects, the plant pot cover system according to the present invention substantially departs from the conventional concepts and designs of the prior art, and in so doing provides an apparatus primarily developed for the purpose of providing a simple and convenient means for decorating a plant pot without disturbing the plant.

### SUMMARY OF THE INVENTION

In view of the foregoing disadvantages inherent in the known types of plant pots now present in the prior art, the present invention provides a new plant pot cover system construction wherein the same can be utilized for providing a simple and convenient means for decorating a plant pot without disturbing the plant.

The general purpose of the present invention, which will be described subsequently in greater detail, is to provide a new plant pot cover system that has many of the advantages of the plant pots mentioned heretofore and many novel features that result in a new plant pot cover system which is not anticipated, rendered obvious, suggested, or even implied by any of the prior art plant pots, either alone or in any combination thereof.

To attain this, the present invention generally comprises a cover having an upper rim formed to fit about a pot, and a plurality of tabs secured to the cover adjacent the upper rim to support the cover about the exterior surface of the pot. The cover may be comprised of various materials, colors, designs, shapes and appearances to provide an aesthetically pleasing appearance to the pot.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a plant pot cover system that will overcome the shortcomings of the prior art devices.

A second object is to provide a plant pot cover system for providing a simple and convenient means for decorating a plant pot without transplanting the plant.

Another object is to provide a plant pot cover system that provides an inexpensive means for changing the appearance of a plant pot.

An additional object is to provide a plant pot cover system that is easily attached to a conventional plant pot.

A further object is to provide a plant pot cover system that is attachable to various shapes and sizes of plant pots.

Another object is to provide a plant pot cover system that enhances the visual appearance of a plant pot without disturbing or damaging the plant.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention attached about a conventional plant pot.

FIG. 2 is an exploded upper perspective view of the present invention with respect to a conventional plant pot.

FIG. 3 is a magnified upper perspective view of a securing tab prior to engaging a conventional plant pot.

FIG. 4 is a magnified upper perspective view of a securing tab engaging a conventional plant pot.

FIG. 5 is a top view of the present invention.

FIG. 6 is a cross sectional view of the present invention taken along line 6-6 of FIG. 5.

FIG. 7 is an exploded cross sectional view of the present invention taken along line 6-6 of FIG. 5 with respect to a conventional plant pot.

FIG. 8 is an exploded cross sectional view of the present invention taken along line 6-6 of FIG. 5 with securing tabs bent downward for insertion of a conventional plant pot.

FIG. 9 is a cross sectional view of the present invention taken along line 6-6 of FIG. 5 attached to a conventional plant pot.

### DESCRIPTION OF THE PREFERRED EMBODIMENT

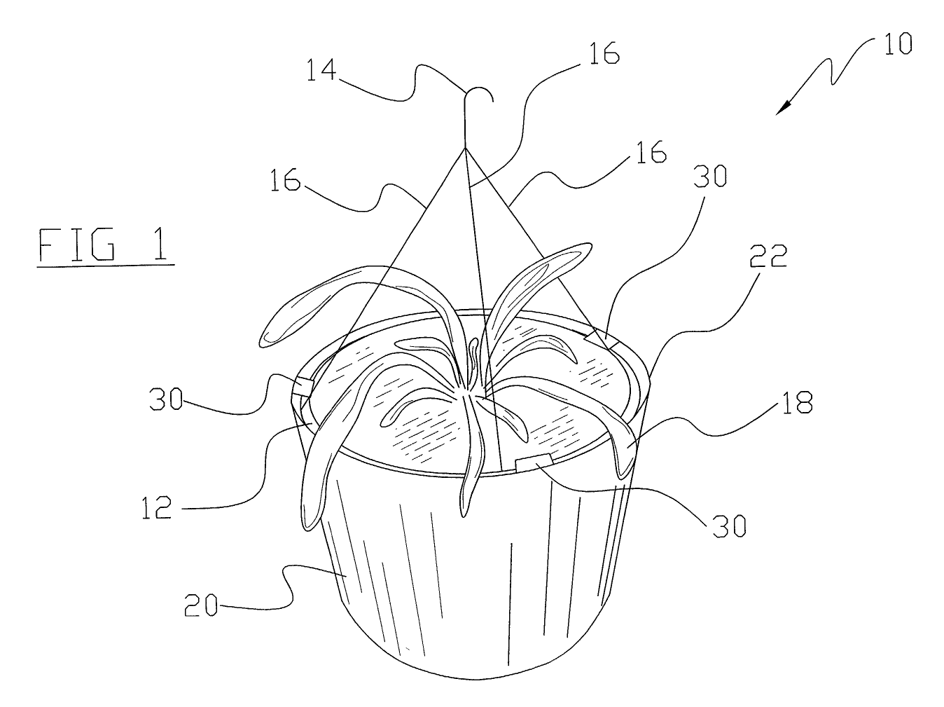

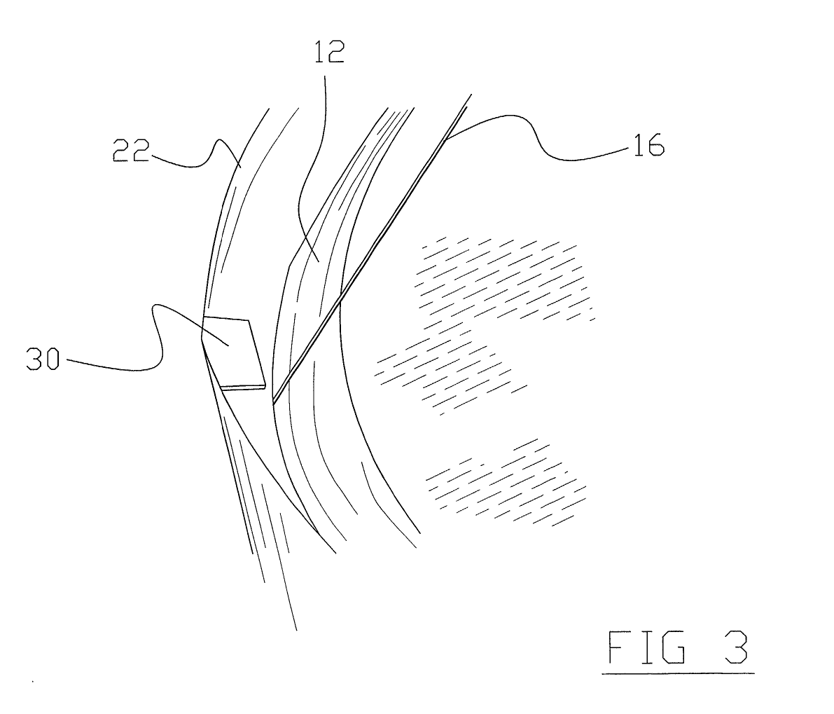

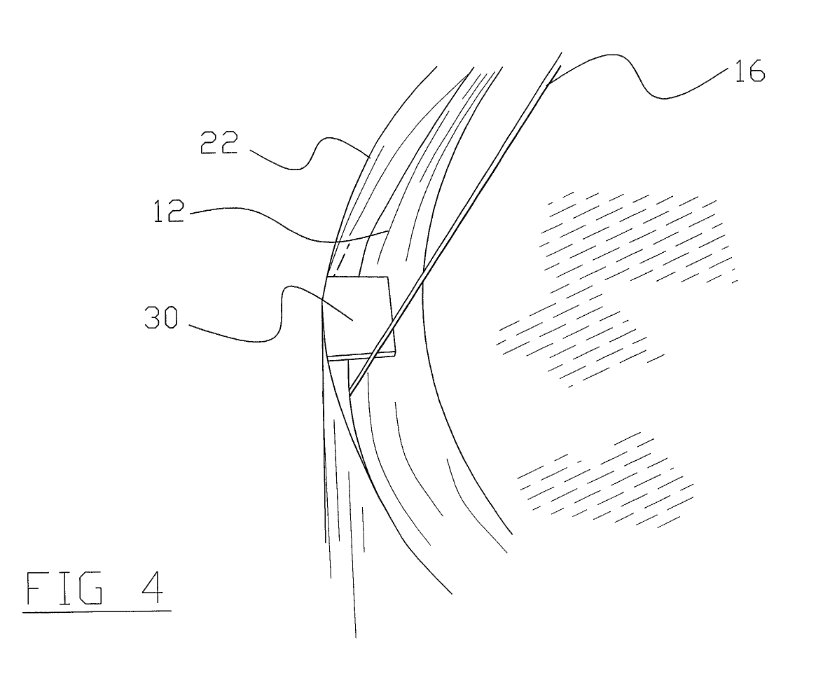

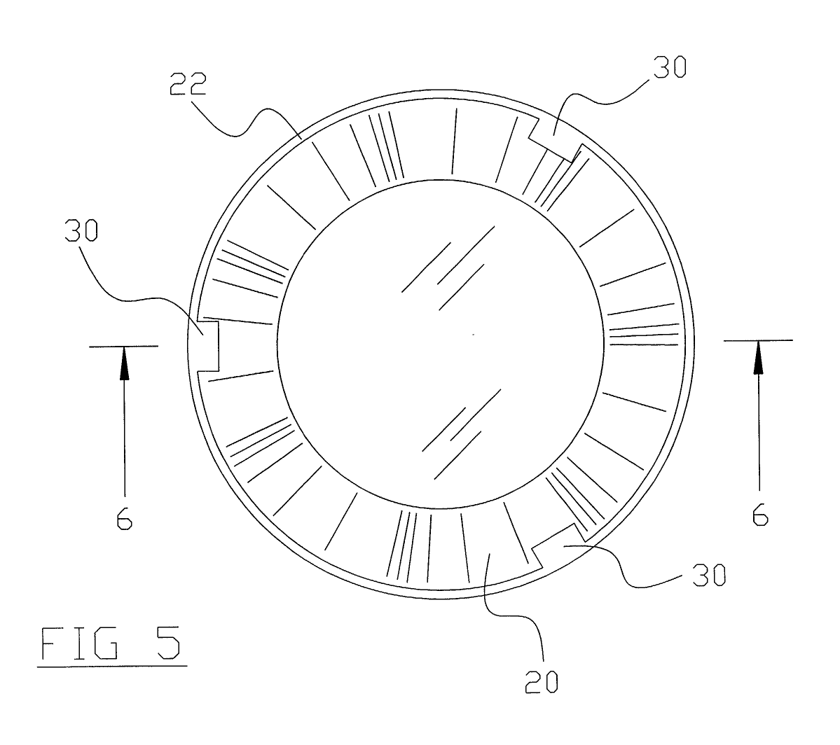

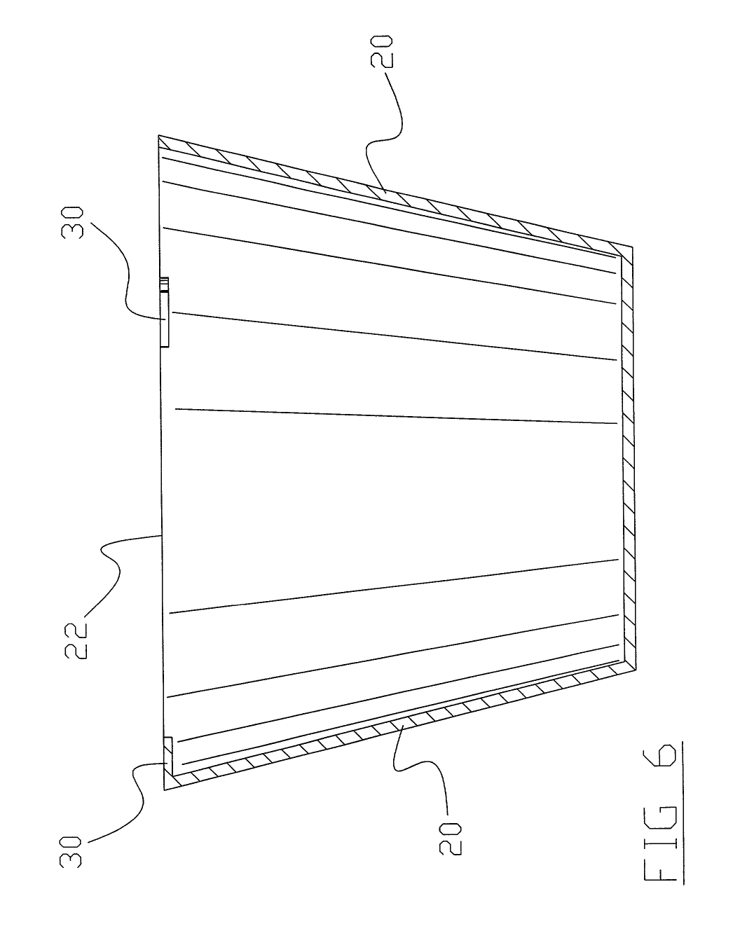

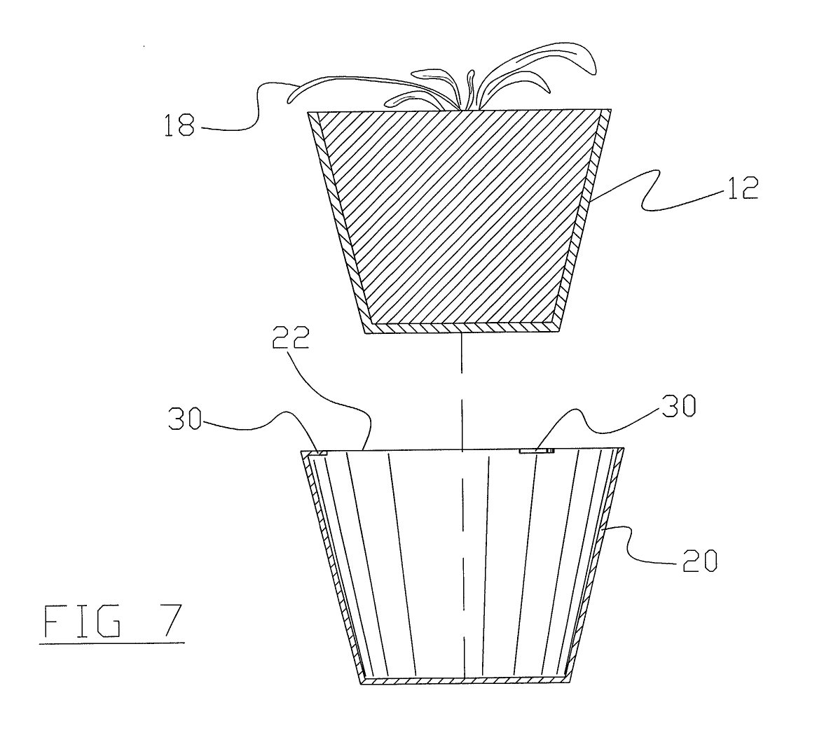

Turning now descriptively to the drawings, in which similar reference characters denote similar elements throughout the several views, FIGS. 1 through 9 illustrate a plant pot cover system 10, which comprises a cover 20 having an upper rim 22 formed to fit about a pot 12, and a plurality of securing tabs 30 secured to the cover 20 adjacent the upper rim 22 to support the cover 20 about the exterior surface of the pot 12. The cover 20 may be comprised of various materials, colors, designs, shapes and appearances to provide an aesthetically pleasing appearance to the pot 12.

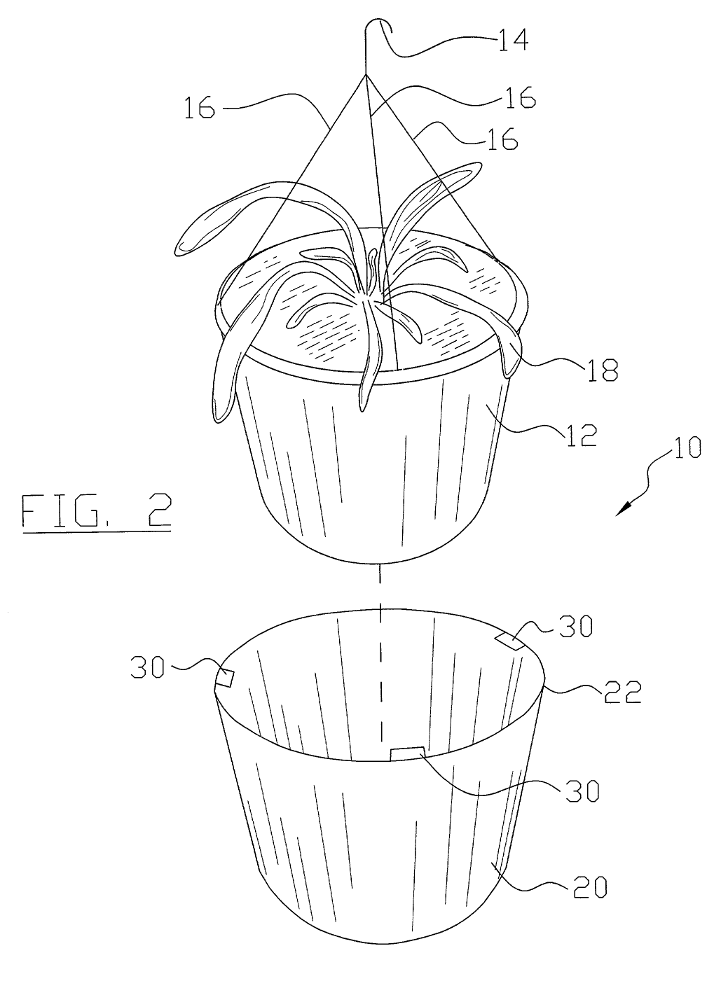

As shown in FIGS. 1 and 2 of the drawings, a conventional pot 12 for holding a plant 18 is typically includes a hook 14 with a plurality of support cables 16 for hanging the plant 18 in an elevated location. The pot 12 may be comprised of various shapes, sizes and structures as is well known in the art.

As shown in FIGS. 1 and 2 of the drawings, the cover 20 is similar in shape and size to the pot 12. The cover 20 is formed to fit about the exterior portion of the pot 12 without requiring disturbance of the plant 18 within the pot 12. The cover 20 has an upper open end defined by an upper rim 22 for receiving the body of the pot 12. The cover 20 may be comprised of various materials, colors, designs, shapes and appearances to provide an aesthetically pleasing appearance to the pot 12 as can be appreciated by one skilled in the art.

As shown in FIGS. 1 and 2 of the drawings, a plurality of securing tabs 30 are attached to an upper portion and/or the upper rim 22 of the cover 20 for attaching to the pot 12. The securing tabs 30 are preferably constructed of a resilient material such as but not limited to plastic or rubber.

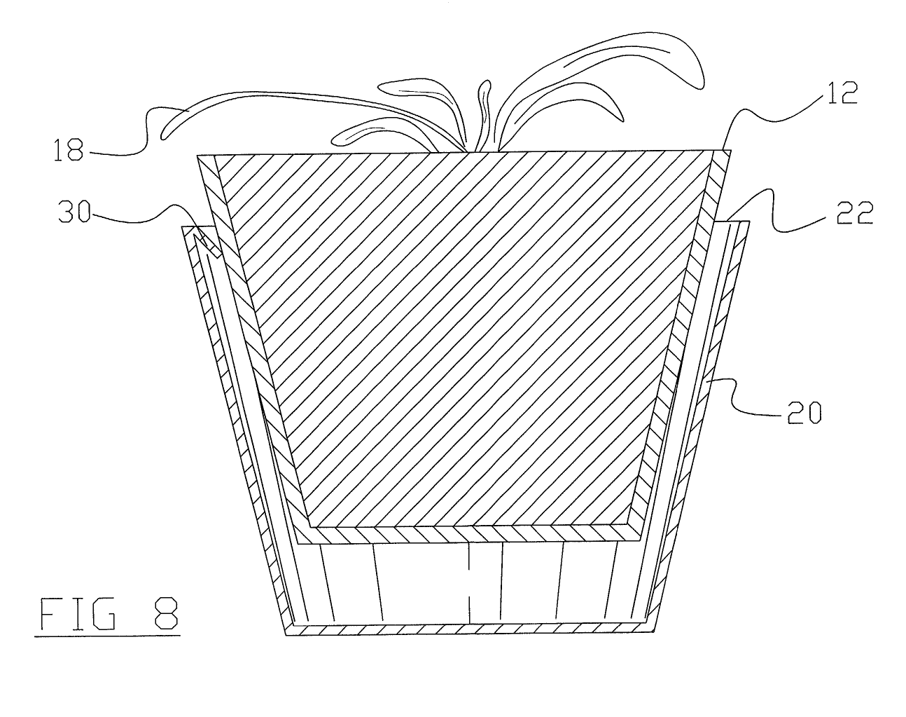

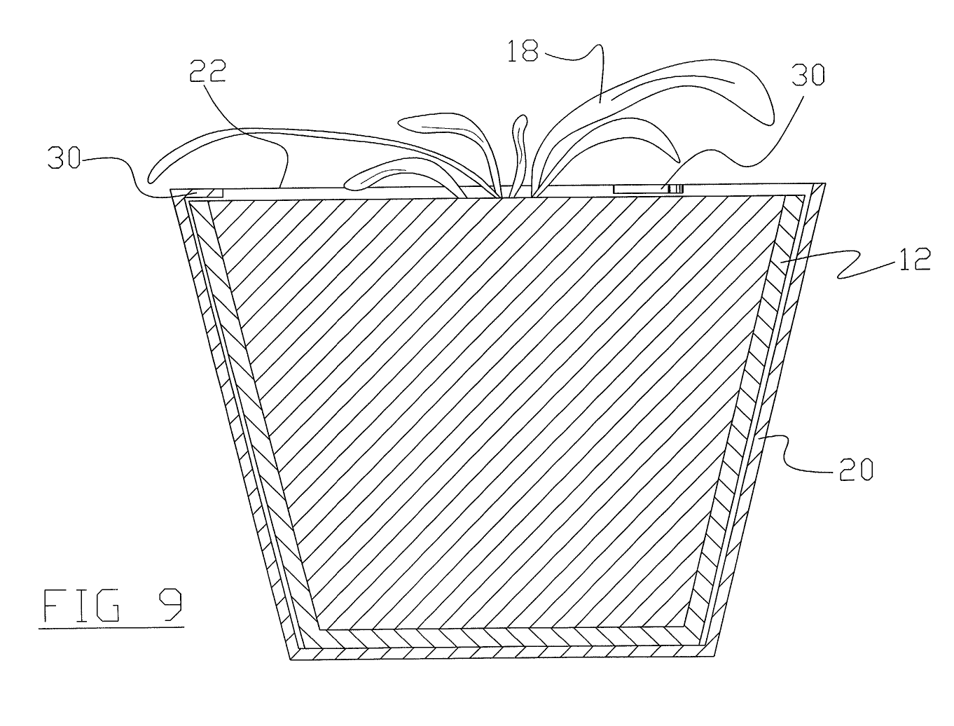

In use, the user positions the cover 20 below the exterior portion of the pot 12. The user then moves the cover 20 upward towards the pot 12. As the cover 20 surrounds the pot 12 the securing tabs 30 bend downward to allow the cover 20 to receive the pot 12 as best shown in FIG. 8. The cover 20 continues to receive the pot 12 until each of the securing tabs 30 are fully extended as best shown in FIG. 9. The plurality of securing tabs 30 support the cover 20 adjacent to and about the pot 12 thereby completely surrounding the pot 12.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A plant pot cover system, comprising:
a cover having an upper opening and an upper rim, wherein said cover is formed to fit about a pot;
a plurality of securing tabs extending inwardly from an upper portion of said cover.

2. The plant pot cover system of claim 1, wherein said plurality of securing tabs extend radially toward a concentric axis of said cover.

3. The plant pot cover system of claim 1, wherein said plurality of securing tabs are comprised of a resilient material.

4. The plant pot cover system of claim 3, wherein said plurality of securing tabs are comprised of a rubber material.

5. The plant pot cover system of claim 3, wherein said plurality of securing tabs are comprised of a plastic material.

6. The plant pot cover system of claim 1, wherein said cover is formed to snugly fit about said pot.

7. The plant pot cover system of claim 6, wherein said cover is formed from stretchable material for conforming to said pot.

8. The plant pot cover system of claim 7, wherein said cover is tapered from said upper opening.

9. The plant pot cover system of claim 1, wherein said plurality of securing tabs are comprised of a rectangular shape.
